(19) United States
(12) Patent Application Publication
(10) Pub. No.: US 2015/0039393 A1
(43) Pub. Date: Feb. 5, 2015

(54) SYSTEMS AND METHODS FOR INCREASING USER ENGAGEMENT BY DETERMINING THE MODE OF TRANSPORT OF THE USERS

(71) Applicant: Chintan Jain, Hillsboro, OR (US)

(72) Inventor: Chintan Jain, Hillsboro, OR (US)

(73) Assignee: EBAY INC., SAN JOSE, CA (US)

(21) Appl. No.: 13/957,745

(22) Filed: Aug. 2, 2013

(51) Int. Cl. G06Q 30/02

(52) U.S. Cl. CPC G06Q 30/0205; G06Q 30/0203
USPC 705/7.32; 705/7.34

(57) ABSTRACT

Systems and methods for detecting geolocation data associated with a traveler and detecting geolocation data associated with a plurality of routes of public conveyances. Detecting a match between the geolocation data associated with the traveler and the geolocation data associated with one of the plurality of routes of public conveyances provides a signal responsive to which the traveler may be engaged electronically. The match between the geolocation data associated with the traveler and the geolocation associated with one of the plurality of routes of public conveyances indicates that the traveler is traveling on a public conveyance and may have time to respond to electronic notifications. A match between an IP address from the user and an IP address associated with a public conveyance indicates that the traveler is traveling on the public conveyance.

### BACKGROUND

Mobile devices provide the ability to track the geolocation of the users at definite intervals. In certain instances, for example if the user is willing to share geolocation data with an entity such as a publication system, the publication system may be able to draw a geo-map of where the user has been, where the user is, and where the user is going. Trains or other public transit almost always have a definite set path to go from point A to point B, and therefore usually travel through definite infinite points when transporting people from point A to point B. This information can in some instances provide useful information both for the publication system and for travelers on public transport.

### DESCRIPTION OF THE DRAWINGS

Some embodiments are illustrated by way of example and not limitation in the figures of the accompanying drawings:

FIG. 1 is a block diagram depicting a system for delivering notifications to a traveler, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based publication system for delivering search results arranged by distance and/or time and/or navigated shopping services, according to an example embodiment.

FIG. 5 is a block diagram illustrating notification modules, according to an example embodiment.

FIG. 6 is an illustration of a train route, according to an example embodiment.

FIGS. 7A and 7B are illustrations of a hardware comparison device for determining whether the user is traveling on public transport, according to an example embodiment.

FIG. 8 is an illustration of a mobile device user interface showing a notification, according to an example embodiment.

FIG. 9 is an illustration of additional notifications, according to an example embodiment.

FIG. 10 is a flowchart illustrating a method for engaging a user traveling on a public conveyance, according to an example embodiment.

FIG. 11 is a diagrammatic representation of a machine in the example form of a computer system within which a set of instructions for causing the machine to perform any one or more of the methodologies discussed herein may be executed.

### DETAILED DESCRIPTION

Example systems and methods for engaging a traveler when the traveler may have free time are described. In some instances it is possible to know with some degree of certainty whether a person is traveling by train or other public conveyance and may therefore have free time. This may be based on the set of geolocation co-ordinates of the traveler because trains have a definite set travel path and the trains travel through that path. If a person's geolocation co-ordinates can be detected, for example, by the person's smartphone communication with a GPS system, a publication system such as an ecommerce site can use that information to engage the traveler in essential as well as non-essential activities on the ecommerce site or the sites of entities related to the ecommerce site. This would not be a safety risk in as much as a person is merely traveling on a train, bus or a cruise ship. Essential activities in which to engage the traveler can include notifications about bids, notifications about saved searches, or any other notifications that will increase either the Gross Merchant Bought or Gross Merchant Volume of the ecommerce site. Non-Essential activities may include things that do not translate essentially into monetary benefits but may lead to improvements for the ecommerce system such as gathering feedback from customers, conducting surveys, and the like.

A publication system such as an ecommerce site is able to track user's smartphone Geolocation data (i.e. the latitude, longitude, altitude, speed, direction etc.) if, in one example embodiment, the user has given permission to share their geolocation data with the publication system. The publication system would be able to collect this geolocation data from a user, and would be able to determine whether the user is traveling via a train. The publication system would determine whether user is traveling by train by comparing a set of user's latest (or recent) geolocation data points (two or more points) with the master route geolocation data of trains or other public conveyances stored in or associated with the publication system. In one example embodiment, the publication system would have captured and stored master route geolocation data of train systems of, in one embodiment, a metro area of interest. Based on the comparison of user's geolocation data and, perhaps over a period of time, the train's master route geolocation data and other parameters such as metadata about the train's velocity and schedule, the publication system would be able to determine that the user is in fact traveling via train. One way for the publication system to determine whether the user is on a train station is by setting up a geofence around the center of each train station in the publication system. The geofences can be centered around the train station and can be of geometrical shapes like a circle or a polygon. If the geofence is circular, the center of the geofence, in one embodiment, can be the (latitude, longitude) of the center of the train station and the radius can be configurable radius of ten meters to one hundred meters. If the user's geolocation data intersects with being in two or more geofences matching with the train velocity, then the publication system can assume that the user is travelling by a train.

Similarly, the publication system can determine whether the person is traveling via other public conveyance such as a public transportation bus by maintaining a list of IP addresses of public transportations buses. If the customer connects to the publication system site through this IP, the publication system can assume that the customer is in fact on the bus.

Once the publication system has determined that the user is traveling via train or bus, the publication system may engage the user by sending users different notifications and increase user engagement. Some of these notifications can be:
Notifications about the publication system's daily Deals which when clicked will take the user to the publication system's daily Deals page.
Notifications about promotions which when clicked will take the user to merchant or publication system promotions.
Notifications about discount codes and coupons which when clicked will take the user to a discount codes and coupons page.
Saved Search Notifications. These are the notifications which are sent to users when their saved items become available on the publication system.
Notifications to ask users to add feedback, such as quality or satisfaction feedback, to a buyer or seller relating to their current or past transactions on the publication system.
Notifications to cross promote the publication system's properties and asking users to download other publication system apps such as, taking eBay as an example, RedLaser, PayPal, eBay Now, StubHub etc.
Notifications to ask users to fill out the publication system's surveys. These notifications when clicked will take the user to the publication system's survey sites.

Also, based on the publication system storing the user's stored daily transportation geolocation data, the publication system can determine the user's daily commute schedule and the location and/or time the user gets ON and get OFF the train or bus. The publication system can use user's daily commuter data along with the train or bus schedule to tailor content on the publication system App based on the commute time remaining.

Because a person will often take public transportation two times a day, usually at the start of their shift and at the end of their shift, the publication system can determine the work location of this user by assuming that the user is at their work between the start and end of their shift. As the publication system knows that the person is in the vicinity of the location where they got off the train or bus, the publication system can use this data to further engage the user by sending users location specific geolocation events. In an example embodiment, if the person gets off in Portland downtown and there is a Macy's sale going on in downtown Portland, the publication system can send the traveler a notification promoting the Macy's sale. In one example embodiment, the user may be provided user notifications about ads of local deals or other promotions based on the time remaining in commute based on a train's velocity data extrapolated by the publication system based on the user's geolocation data for that day, or a fixed time when user usually exits the train. In an example embodiment, the movement detection function of the user's smart phone may, through Wi-Fi or GPS signals, alert the publication that the user is moving within the train. If that movement coincides with publication system master route geolocation data (including the geofences set up in the publication system) that indicates the train is approaching a stop at the time of user movement, it may be assumed that the user is moving to proceed to exit at that stop. Notifications relating to that stop may then be provided to the user.

In an example embodiment, local content, such as coffee shop specials at or near the user's usual stop could be provided to the user.

In an example embodiment, the publication system can determine whether the person is traveling on a cruise ship by maintaining a set of IP addresses for cruise ships. The publication system will maintain the cruise ship IP address, the cruise ship itinerary and daily cruise ship schedule. If the publication system finds a match between the cruise ship IP address and the user's smartphone IP address, the publication system can use this information to promote, sell or market cruise merchandise, or to engage the user by sending users user notifications such as:
Notifications to promote or sell off shore excursions packages.
Notifications to advertise local port merchants' goods where the ship will travel.
Notifications including those listed above for users of ground transportation.
   Furthermore, the publication system can tailor the timing of notifications by using the cruise itinerary. In one embodiment, the publication system may know that the cruise ship is going to in Ketchikan, Ak. at 5 PM on a given day and may then send the travelers on the cruise ship user notifications relevant primarily for Ketcikan, Ak. merchants or that port's offshore excursions. Similarly, the publication system can use the cruise daily schedule to determine the time when the user will be free to be engaged in essential or non-essential activities.

### EXAMPLE SYSTEM

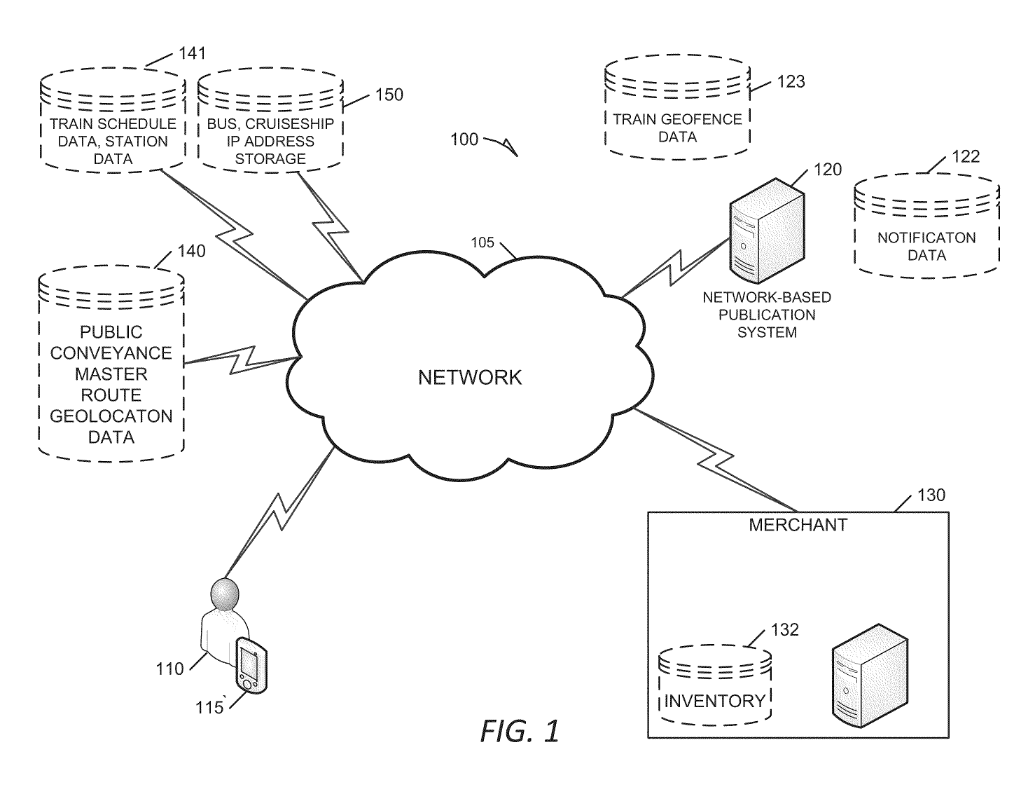

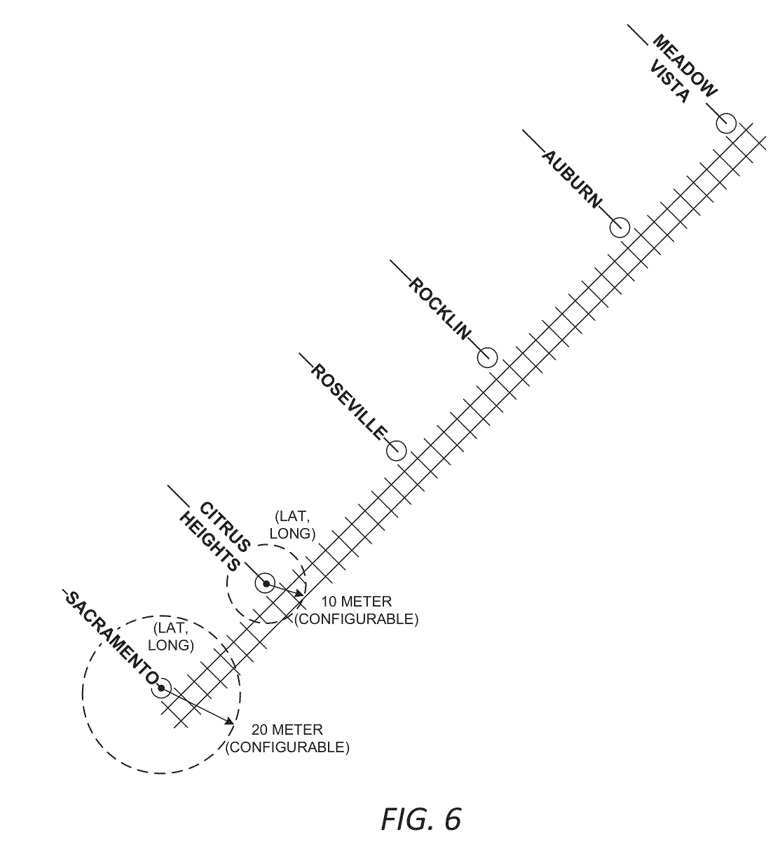

FIG. 1A is a block diagram depicting a system 100 for delivering search results, according to an example embodiment. The system 100 can include a user 110, a network-based publication system 120 with a search engine, and one or more merchants 130 (and merchant systems). Associated with the network-based publication system 120 may be database 122 that includes notification data of the type discussed subsequently, and 123 that includes train geofence data discussed with respect to FIG. 6. In an example, the user 110 can connect to the network-based publication system 120 via a mobile device 115 (e.g., desktop, laptop, smart phone, PDA, or similar electronic device capable of some form of data connectivity). The network-based publication system 120 will receive and process a query from the user's mobile device 115. Generally, location information specifying the physical or geographical location of the user 110 will be received with the query. In an example embodiment, the mobile device 115 can include a GPS unit to inform the mobile device 115 of its location, such that the location information of the mobile device 115 can be shared with the network-based publication system 120. Other known techniques for deriving location information may be used with both mobile and non-mobile client computing devices, for example, such as desktop computers, etc. For instance, with some embodiments, the location information indicating the location of the user 110 may be explicitly specified by the user 110, for example, by the user 110 interacting with a map.

In an example, the merchant 130 can operate computer systems, such as an inventory system 132 or a POS system 131. The network-based publication system 120 can interact with any of the systems 131, 132 used by merchant 130 for operation of the merchant's retail or service business. In an example, the network-based publication system 120 can work with both POS system 131 and inventory system 132 to obtain access to inventory available at individual retail locations run by the merchant 130. This inventory information can be used in both generating product or service listings, and selecting and ordering search results served by the network-based publication system 120.

In an example, public conveyance master route data may be stored in database 140 at or associated with the network-based publication system 120. Master route data for various public conveyances, train, bus, and the like, may be obtained, as discussed below, by known technological systems. This master route data may be used to determine whether a traveler is traveling by one of the various public conveyance systems.

In an example, train schedule data and train station data may be stored in database 141 at or associated with the network-based publication system 120. Similarly to the data for database 140, the data may be obtained by known technological systems. In another example, database 150 may include bus and cruise ship IP addresses to be used as discussed below.

### EXAMPLE OPERATING ENVIRONMENT

With some embodiments, the user may explicitly indicate or specify his or her current location for use in deriving a distance or travel time to stores offering products/services. However, with some embodiments, location information of the user may be derived with a mobile computing device of the user. In some additional embodiments, the user may explicitly indicate or specify his daily travelled commute route (or some other route) for use in determining a set of search results based on the distance or travel time to stores offering products/services. However, with some embodiments, location information (and particularly, the commute or travel path) of the user may be derived with a mobile computing device of the user.

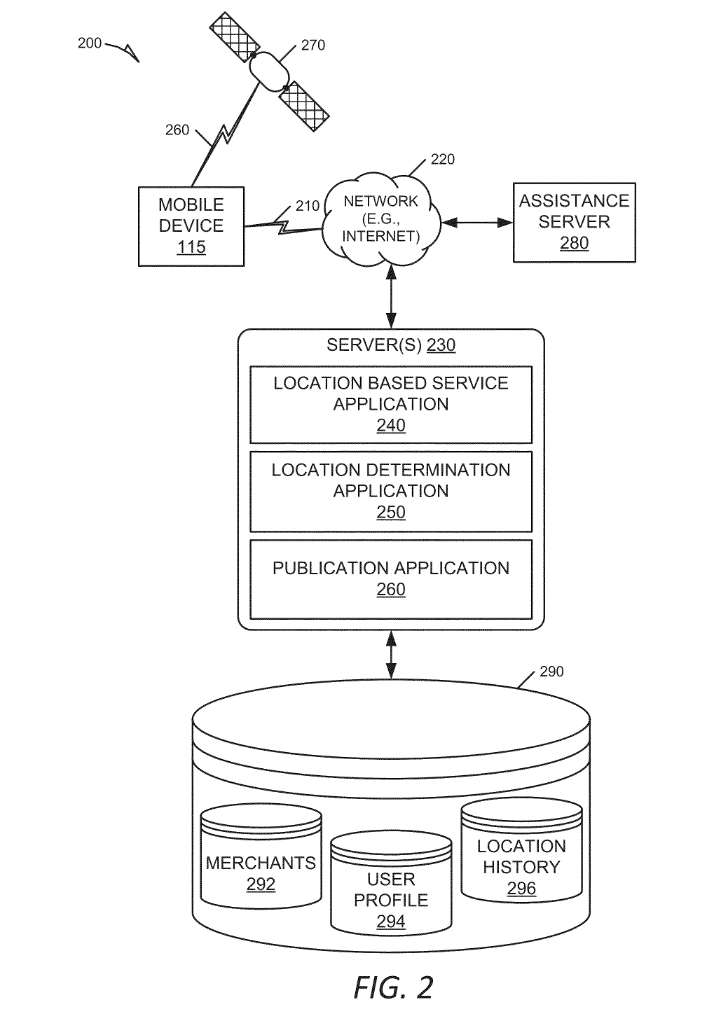

FIG. 2 is a block diagram illustrating an environment 200 for operating a mobile device 115, according to an example embodiment. The environment 200 is an example environment within which methods of serving search results can be operated. In another example, environment 200 can host a navigated shopping service, which can also include the methods of serving search results discussed herein. The environment 200 can include a mobile device 115, a communication connection 210, a network 220, servers 230, a communication satellite 270, a merchant server 280, and a database 290. The servers 230 can optionally include location based service application 240, location determination application 250, publication application 260 with search engine 261, and payment application 265. The database 290 can optionally include merchant databases 292, user profile database 294, and/or location history database 296. The mobile device 115 represents one example device that can be utilized by a user to receive offers and share context information associated with the user. The mobile device 115 may be any of a variety of types of devices (for example, a cellular telephone, a PDA, a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

In an example embodiment, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. In an example embodiment, one or more servers 230 may execute location based service (LBS) applications 240, which interoperate with software executing on the mobile device 115, to provide LBSs to a user. LBSs can use knowledge of the device's location, and/or the location of other devices and/or retail stores, etc., to provide location-specific information, recommendations, notifications, interactive capabilities, and/or other functionality to a user. With some embodiments, the LBS operates in conjunction with the publication application 260 and search engine 261, in particular, to provide search results that are arranged based on the distance or travel time between a mobile device 115 (or other computer device) and a retail store. For example, an LBS application 240 can provide location data to a network-based publication system 120, which can then be used to arrange a set of search results, based on distance and/or travel time between two locations. Knowledge of the mobile device's location, and/or the location of other devices, may be obtained through interoperation of the mobile device 115 with a location determination application 250 executing on one or more of the servers 230. Location information may also be provided by the mobile device 115, without use of a location determination application such as application 250. In certain examples, the mobile device 115 may have some limited location determination capabilities that are augmented by the location determination application 250.

### EXAMPLE MOBILE DEVICE

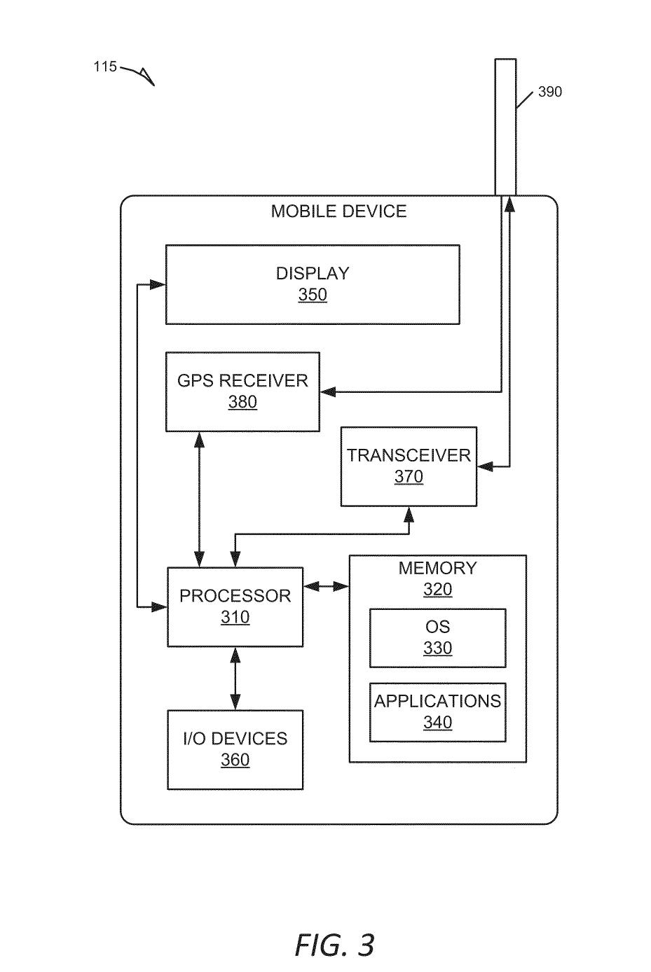

FIG. 3 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 330, as well as application programs 340, such as a mobile location enabled applications that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

Additional detail regarding providing and receiving location-based services can be found in U.S. Pat. No. 7,848,765, titled “Location-Based Services,” granted to Phillips et al. and assigned to Where, Inc. of Boston, Mass., which is hereby incorporated by reference.

An example geolocation concept discussed within U.S. Pat. No. 7,848,765 is a geofence. A geofence can be defined as a perimeter or boundary around a physical location or mobile object (e.g., a user). A geofence can be as simple as a radius around a physical location defining a circular region around the location. However, a geofence can be any geometric shape or an arbitrary boundary drawn on a map. A geofence can be used to determine a geographical area of interest for the calculation of demographics, advertising, presenting search results, or similar purposes. Geofences can be used in conjunction with identifying and presenting search results, as described herein. For example, a geofence can be used to assist in determining whether a user (or mobile device associated with the user) is within a geographic area of a particular merchant. If the user is within a geofence established by the merchant or the publication system, the systems discussed herein can use that information to identify and present search results (e.g., via a mobile device associated with the user).

### EXAMPLE PLATFORM ARCHITECTURE

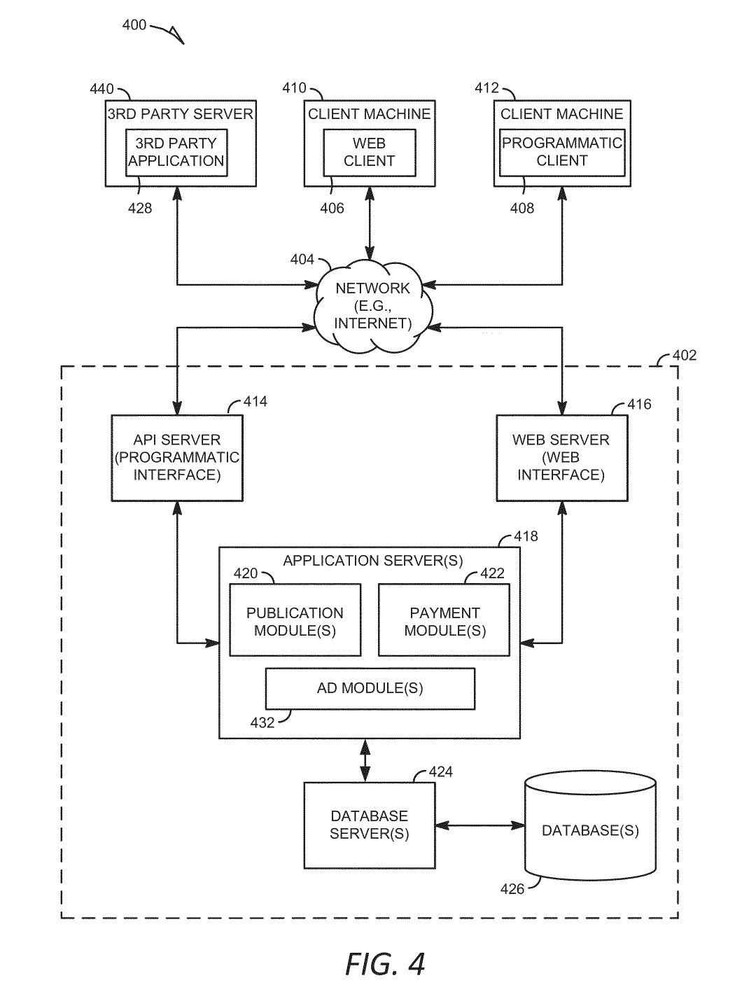

FIG. 4 is a block diagram illustrating a network-based system 400 for processing a search query, and presenting search results, as described more fully herein. The network-based system 400 can also provide navigated shopping services as described more fully herein. The block diagram depicts a network-based system 400 (in the exemplary form of a client-server system), within which an example embodiment can be deployed. A networked system 402 is shown, in the example form of a network-based location-aware publication, advertisement, or marketplace system, that provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Washington State) and a programmatic client 408 executing on respective client machines 410 and 412. In an example, the client machines 410 and 412 can be in the form of a mobile device, such as mobile device 115.

An Application Programming Interface (API) server 414 and a web server 416 are coupled to, and provide programmatic and web interfaces respectively to, one or more application servers 418. The application servers 418 host one or more publication modules 420 (in certain examples, these can also include search engine modules, commerce modules, advertising modules, and marketplace modules, to name a few), payment modules 422, dynamic offer modules 432, and optionally shopping modules 434. The application servers 418 are, in turn, shown to be coupled to one or more database servers 424 that facilitate access to one or more databases 426. In some examples, the application server(s) 418 can access the database(s) 426 directly without the need for a database server(s) 424.

The publication modules 420 may provide a number of publication and search functions and services to users that access the networked system 402. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 may also be configured to present or facilitate a redemption of offers, generated by the location-aware (dynamic) offer modules 432, to a user during checkout (or prior to checkout, while the user is still actively shopping). The offer modules 432 may provide dynamic context sensitive offers (e.g., coupons or immediate discount deals on targeted products or services) to users of the networked system 402. The offer modules 432 can be configured to use all of the various communication mechanisms provided by the networked system 402 to present offer options to users. The offer options can be personalized based on current location, time of day, user profile data, past purchase history, or recent physical or online behaviors recorded by the network-based system 400, among other things (e.g., context information). While the publication modules 420, payment modules 422, and offer modules 432 are shown in FIG. 4 to all form part of the networked system 402, it will be appreciated that, in alternative embodiments, the payment modules 422 may form part of a payment service that is separate and distinct from the networked system 402. Additionally, in some examples, the offer modules 432 may be part of the payment service or may form an offer generation service separate and distinct from the networked system 402.

In certain examples, the shopping modules 434 may provide real-time navigation route updates listing physical retail outlets that have items on a shopping list uploaded by a user of the networked system 402. The shopping modules 434 can be configured to use all of the various communication mechanisms provided by the networked system 402 to transmit information to a client machine, such as client machine 412. The shopping modules 434 can also present special offers available from retail merchants, such as merchant 130, along a user's current navigation route. The offers can be personalized based on current location, time of day, user profile data, past purchase history, or recent physical or online behaviors recorded by the network-based system 400, among other things.

Further, while the system 400 shown in FIG. 4 employs a client-server architecture, the present invention is of course not limited to such an architecture, and could equally well find application in a distributed, or peer-to-peer, architecture system, for example. The various publication modules 420, payment modules 422, and offer modules 432 could also be implemented as standalone systems or software programs, which do not necessarily have networking capabilities.

The web client 406 accesses the various publication modules 420, payment modules 422, and offer modules 432 via the web interface supported by the web server 416. Similarly, the programmatic client 408 accesses the various services and functions provided by the publication modules 420, payment modules 422, and offer modules 432 via the programmatic interface provided by the API server 414. The programmatic client 408 may, for example, be a smartphone application that enables users to communicate search queries to the system 400 while leveraging user profile data and current location information provided by the smartphone or accessed over the network 404.

FIG. 4 also illustrates a third party application 428, executing on a third party server machine 440, as having programmatic access to the networked system 402 via the programmatic interface provided by the API server 414. In an example embodiment, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants with access to the offer modules 432 for configuration purposes. In certain examples, merchants can use programmatic interfaces provided by the API server 414 to develop and implement rules-based pricing schemes that can be implemented via the publication modules 420, payment modules 422, offer modules 432, and optionally shopping modules 434.

### EXAMPLE NOTIFICATION MODULES

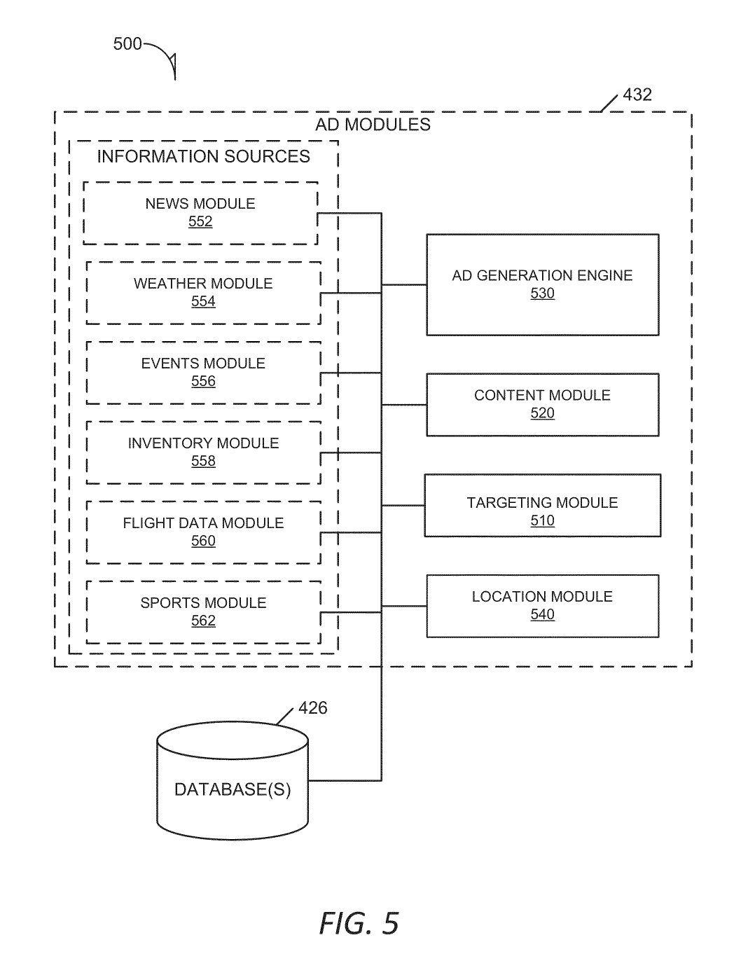

FIG. 5 is a block diagram illustrating context sensitive advertisement modules (ad modules 432), according to an example embodiment. In this example, the ad modules 432 can include a targeting module 510, a content module 520, an ad generation module 530, and various information sources for context information. The ad modules 432 can also include a location module 540. Context information sources can include a news module 552, a weather module 554, an events module 556, an inventory module 558, a flight data module 560, and a sports module 562, to name just a few. In an example, the ad modules 432 can access database 426 to store and/or retrieve advertisement rules and campaign information, context data, location data, as well as other information to enable context sensitive advertisements to be generated, delivered, and updated.

In an example, the content module 520 can gather and deliver context relevant, or other, content to the ad generation module 530 based on advertisement rules and campaign information provided by advertisers. The content module 520 can interface with each of the various context information sources to obtain and dynamically update advertisement content.

In an example, the targeting module 510 can use context information from the various information sources to dynamically target advertisements to users based on the current context (e.g., location, mode of travel, time, events, weather, and the like).

In an example, the location module 540 is configured to receive location data from a mobile device, such as mobile device 115, and determine from the location data one or more participating merchant locations that are within a pre-define proximity. In some examples, the location module 540 can receive GPS-type coordinates (e.g., longitude and latitude), which can be used to establish a current location associated with a mobile device (and thus a user of the mobile device). These coordinates can be received over time, stored, and parsed to determine mode of travel, speed, direction, and path of travel of the user. This can be used to determine whether the user is in a public conveyance such as a train. Using the longitude and latitude coordinates, the location module 540 can determine if any merchants with physical locations registered with the networked system 402 are in proximity to the current location associated with the user. In certain examples, the location module 540 can receive other location determining information from a mobile device. In an example embodiment, some merchants may broadcast specific wireless network signals that can be received by a mobile device, such as mobile device 115. Once received, the mobile device 115 can include programming or circuitry to translate the signal into a specific location or the mobile device 115 can simply retransmit the unique signal to the location module 540. In an example, a merchant location can transmit a unique SSID, which the location module can be programmed to interpret as identifying a specific merchant location. In another example, the merchant may broadcast a unique SSID within all of its locations and the location module 540 can be programmed to use a combination of the unique SSID and other location data (e.g., GPS coordinates or cell tower locations) to identify a specific location.

In an example, the news module 552 can access various sources of news information over the network 404. The news module 552 can receive keywords from the ad generation engine 530 related to advertisement content or rules that trigger based on specific news stories or events.

In an example, the weather module 554 can access and deliver weather related data and alerts to the ad generation engine 530. In certain examples, the weather module 554 can receive location data from the location module 540 to target the weather data gathering. In some examples, the ad generation engine 530 can query the weather module 554 for information such as, local temperature, weather alerts, forecast, among other things.

In an example, the event module 556 can access and deliver local event information to the ad generation module 530. For example, the event module 556 can receive location information from the location module 540 and based on the location information provide data on local sporting events, theater information, and other event or festival information for the location.

In an example, the inventory module 558 can track inventory available at individual locations associated with a merchant using the networked system 402. The inventory module 558 can maintain inventory associated with products or services that merchant has included within offer generation rules used by the ad generation engine 530 to generate context sensitive advertisements. In certain examples, the inventory module 558 maintains inventory information within a local database, such as database 426. In another example, the inventory module 558 can be configured to access remote inventory information maintained by individual merchants. In additional examples, the inventory module 558 can be configured to interact with a third-party real-time inventory provider, such as MILO (from eBay, Inc. of San Jose, Calif.). The inventory module 558 can also be configured to delivery real-time (or near real-time) inventory information from multiple different sources. In some examples, each merchant may make inventory information available via different mechanism (e.g., API, XML feed, batch up loads, etc . . . ). The inventory module 558 can convert from various incoming formats to a common format used by the ad generation engine 530 to generate context sensitive dynamic advertisements based on current inventory available within individual local retail outlets.

Additional details regarding the functionality provided by the location-aware offer modules 432 are detailed in reference to FIGS. 6-8.

FIG. 6 is an illustration of a train route 600, according to an example embodiment. Train route 602 is a hypothetical train route between Sacramento, Calif. and Meadow Vista, Calif., with intermediate stops at Citrus Heights, Roseville, Rocklin, and Auburn. As discussed above, a publication system such as an ecommerce site is able to track user's smartphone geolocation data (i.e. the latitude, longitude, altitude, speed, direction etc.) if, in one example embodiment, the user has given permission to share their geolocation data with the publication system. The publication system would be able to collect this geolocation data from a user, specifically the latitude, longitude, speed and direction, and would be able to determine whether the user is traveling via train on track 602. The publication system would determine whether user is traveling by train by comparing a set of two or more of user's latest or recent geolocation data points to detect if they lie within in a geofence (as discussed below). This comparison may be accomplished using the master route geolocation data of trains or other public conveyances stored in the database of the publication system. In one example embodiment, the publication system would have captured and stored master route geolocation data of train systems of the metro area of interest. Based on the comparison of user's geolocation data and, perhaps over a period of time, the train's master route geolocation data and other parameters such as metadata about the train's velocity and schedule, the publication system would be able to determine that the user is in fact traveling via a train. In an example embodiment, tracking the above train geolocation data between, say, the Rocklin station and the Auburn station and by tracking closeness of pulse data would be able to determine the train's velocity and, knowing the distance between the Rocklin station and the Auburn station, could calculate the time of the train's arrive in Auburn. In other words, by tracking the velocity, the publication system can calculate whether the training is slowing down and, depending on the train's geolocation as it slows, the slowing down could mean the train is slowing to a stop in Auburn. A way for the publication system to determine whether the user is on a train is by setting up a geofence around some of or each of the train stations, the data for which is stored in the database of the publication system. Two such geofences are seen as dashed circles in FIG. 6 as examples. The geofences can be centered around a train station and can be of a geometrical shapes like a circle or a polygon. If the geofence is circular, the center of the geofence can be the latitude and longitude of the center of the train station and the radius can be a configurable radius of ten meters to a few hundred meters. If the user's geolocation data lies in two or more geofences of distinct train stations matching with the train velocity, the example derived from the above master route geolocation data, then the publication system can assume that the user is travelling by a train.

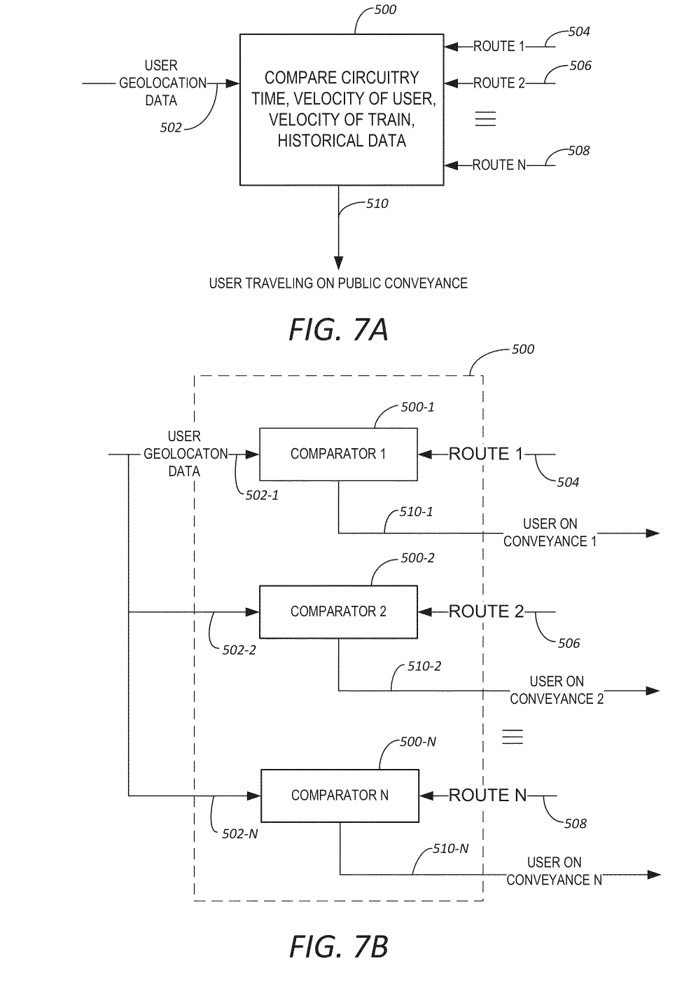

FIGS. 7A and 7B are an illustration of a hardware comparison device for determining whether the user is traveling on public transport, according to an example embodiment. As discussed above, a publication system such as an ecommerce site is able to track user's smartphone Geolocation data (i.e. the latitude, longitude, altitude, speed, direction etc.). The publication system would be able to collect this geolocation data from a user, in one embodiment the latitude, longitude, speed and direction, and would be able to determine whether the user is traveling via train. The publication system would determine whether user is traveling by train by comparing a set of user's latest geolocation data points if they are in the geofence (two or more points) with the master route geolocation data of trains or other public conveyances stored in the publication system. In one example embodiment, the publication system would have captured and stored master route geolocation data of train systems of the metro area of interest. Based on the comparison of user's geolocation data and, perhaps over a period of time, the train's master route geolocation data and other parameters such as metadata about the train's velocity and schedule, the publication system would be able to determine that the user is in fact traveling via train. This may be seen in general terms in FIG. 7A. In FIG. 7A the user geolocation data is used as an input, in one embodiment, a serial input, to compare circuitry 500. Other inputs to compare circuitry 500 are relevant data from the stored master train route data for Route 1 over line 504, Route 2 over line 506, , Route N, over line 508. These signals, the user geolocation signal and the signals representing the various routes, can be serialized over time. The user geolocation signals can be compared with the geolocation signals of various routes 1, 2, . . . , N by compare circuitry 500 over time If there is a match between the user geolocation signals over time and the geolocation signals of any one of the routes from the master route geolocation data of various train routes, it can be indicated, by a signal on line 510, that the user is traveling on a train corresponding to the route with which there is the aforesaid match.

This can be seen in additional detail in FIG. 7B where compare circuitry 500 of FIG. 7A is seen to include, in one embodiment, comparator 1, 500-1, comparator 2, 500-2, . . . , comparator N, 500-N. Lines 502-1, 502-2, . . . , 502 N are lines over which the user geolocation data can be input to the comparators. The other input to each comparator is the train master route geolocation data for various routes as discussed above. The user geolocation data can vary over time, and the route geolocation data can vary over time. Beginning with a reference location and time at which the user geolocation signal coincides with one or more of the route geolocation signals, the comparison in the comparators can be undertaken. If there is then a match between the serial string of user geolocation data 502 to any of the route geolocation data 504, 506, 508 over time, the comparator at which the match is detected may send a signal over the respective line 510-1, 510-2, . . . , 510-N to indicate that the user is on a particular train (or other conveyance since the same method may be carried out for bus, and for cruise ship, with the difference, in one embodiment, being that IP addresses may be used instead of master geolocation data).

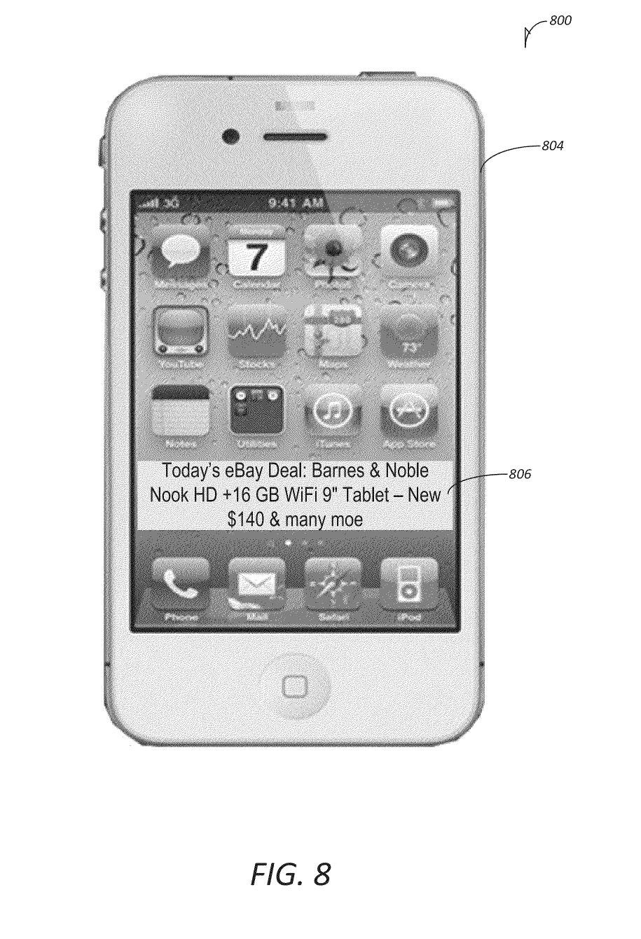

FIG. 8 is an illustration 800 of a mobile user interface 805 showing notification 806, according to an example embodiment. In this illustration notification 802 has been sent to mobile device 804 of a user who is on a public conveyance, here a train. The notification is seen at 802 to be notification of a daily deal at Barnes & Noble, the notification being sent when it is believed that the user is approaching a station at which a Barnes and Noble store is located, and, from stored user data, is deemed that the user is likely to exit the train. This deeming of the user's probable exit can be reached as discussed above, with respect to the daily schedule pattern of the user, or movement of the smartphone within the train, indicating possible exit from the train at the upcoming station.

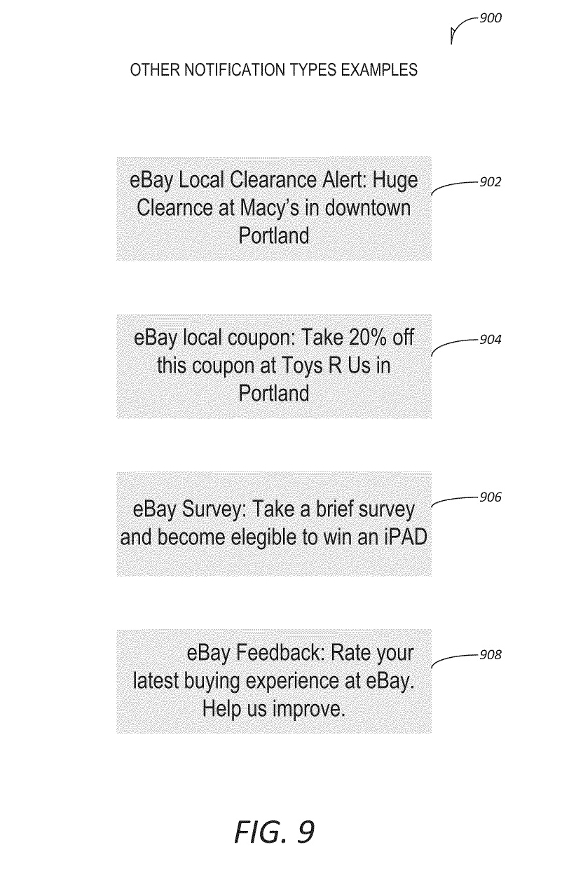

FIG. 9 is an illustration of additional notifications 900, according to an example embodiment. In an example embodiment, notifications 902 and 904 are notifications that may be sent to the user who is deemed to be exiting a train at a Portland station. Notifications 906, 908 are notifications requesting that a user on a public conveyance to take a survey and to provide feedback, the assumption being that a user on a train presumably has more time, and therefore may be motivated to, take the survey and provide feedback.

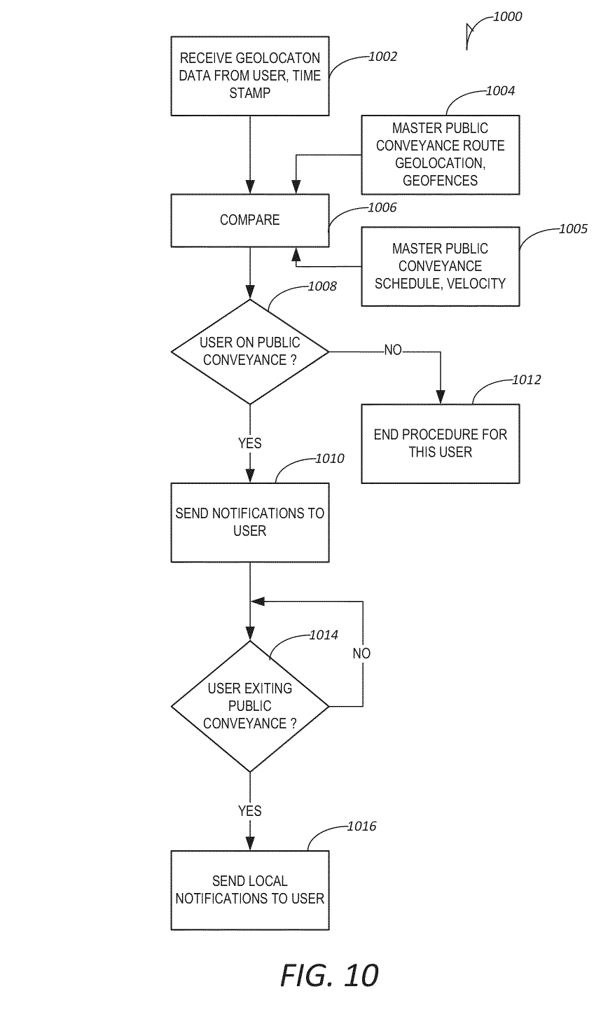

FIG. 10 is a flowchart illustrating a method for engaging users, according to an example embodiment. The publication system tracks the user's smartphone geolocation data (i.e. the latitude, longitude, altitude, speed, direction etc.) and would therefore receive the geolocation data of the traveler as at 1002. This may be accomplished by detecting signals resulting from the mobile device 115 of FIG. 4 interacting with a GPS system via satellite as illustrated in FIG. 2. This geolocation data may be compared over time, as discussed with respect to comparator 500 of FIGS. 7A and 7B, with master route geolocation data from appropriate public conveyances, collected as at 1004 in database 140 of FIG. 1. The publication system would determine as at 1008 whether user is traveling by train by comparing a set of user's latest geolocation data points (two or more points) with the master route geolocation data of trains or various public conveyances stored in the publication system. This compare function 1006 and decision function 1008 may be accomplished by the comparator system of FIG. 7B. If decision 1008 is that the user is in fact traveling via train, then notifications may be sent to the user as at 1010. This may be as illustrated at 906, 908 of FIG. 9. If the user is detected as about to depart the conveyance at a known location, notification relating to local business may be sent to the user at 1016. This may be as illustrated at 806 of FIG. 8.

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

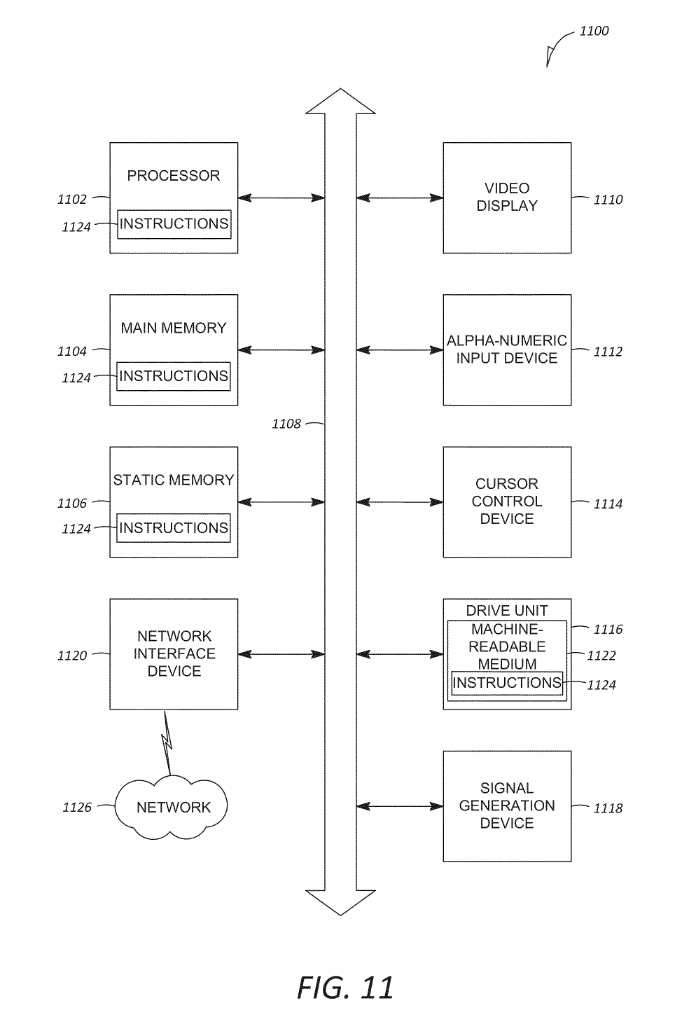

FIG. 11 is a block diagram of machine in the example form of a computer system 1100 within which there may be executed instructions 1124 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., user interface (UI) navigation device or computer mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of data structures and instructions 1124 (e.g., software) embodying or used by any one or more of the methodologies or functions described herein. The instructions 1124 may also reside, completely or at least partially, within the main memory 1104, static memory 1106, and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions for execution by the machine and that cause the machine to perform any one or more of the methodologies of the embodiments of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks. A “machine-readable storage medium” shall also include devices that may be interpreted as transitory, such as register memory, processor cache, and RAM, among others. The definitions provided herein of machine-readable medium and machine-readable storage medium are applicable even if the machine-readable medium is further characterized as being “non-transitory.” For example, any addition of “non-transitory,” such as non-transitory machine-readable storage medium, is intended to continue to encompass register memory, processor cache and RAM, among other memory devices.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present inventive subject matter has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
detecting geolocation data associated with the user;
detecting geolocation data associated with a plurality of public conveyances;
detecting a match between the geolocation data associated with the user and the geolocation data associated with one of the plurality of public conveyances; and
responsive to detecting the match, engaging the user electronically.

2. The method of claim 1 wherein the geolocation data associated with a plurality of public conveyances comprises the IP addresses of cruise ships or buses and detecting the match comprises detecting a match between the IP address of a mobile device of the user and the IP address of one of the plurality of public conveyances.

3. The method of claim 1 wherein the geolocation data associated with a plurality of public conveyances comprises route data of the plurality of public conveyances and detecting the match comprises detecting a match between the geolocation data associated with the user and the route data of one of the public conveyances.

4. The method of claim 1 wherein engaging the user electronically comprises providing notifications relating to ecommerce.

5. The method of claim 4 wherein the notifications relating to ecommerce include one of a request to take a survey and a request for feedback other than a survey.

6. The method of claim 1, wherein detecting a match between the geolocation data associated with the user and the geolocation data associated with one of the plurality of public conveyances comprises detecting a match between signals indicating movement of a mobile device associated with the user and signals indicating that a conveyance is approaching a stop.

7. The method of claim 1 wherein the match between the geolocation data associated with the user and the geolocation data associated with one of the plurality of public conveyances indicates that the user is traveling via a public conveyance.

8. The method of claim 1, wherein the geolocation data associated with the user comprises a plurality of location data points, the method further including detecting geofence data associated with a train station, the match comprising a match between at least two of the plurality of location data points and the geofence data, and the match indicating that the user is on a public conveyance.

9. A system comprising:
one or more computer processors and computer storage configured to detect geolocation data associated with the user;
detect geolocation data associated with a plurality of public conveyances;
detect a match between the geolocation data associated with the user and the geolocation data associated with one of the plurality of public conveyances; and
responsive to detecting the match, engage the user electronically.

10. The system of claim 9 wherein the geolocation data associated with a plurality of public conveyances comprises the IP addresses of cruise ships or buses and detection of the match comprises detection of a match between the IP address of a mobile device of the user and the IP address of one of the plurality of public conveyances.

11. The system of claim 9 wherein the geolocation data associated with a plurality of public conveyances comprises route data of the plurality of public conveyances and detection of the match comprises detection of a match between the geolocation data associated with the user and the route data of one of the public conveyances.

12. The method of claim 9 wherein engagement of the user electronically comprises providing notifications relating to ecommerce.

13. The method of claim 12 wherein the notifications relating to ecommerce include one of a request to take a survey and a request for feedback other than a survey.

14. The method of claim 9, wherein detector of a match between the geolocation data associated with the user and the geolocation data associated with one of the plurality of public conveyances comprises detection of a match between signals that indicate movement of a mobile device associated with the user and signals that indicate that a conveyance is approaching a stop.

15. The method of claim 9 wherein the match between the geolocation data associated with the user and the geolocation data associated with one of the plurality of public conveyances indicates that the user is traveling via a public conveyance.

16. The method of claim 9, wherein the geolocation data associated with the user comprises a plurality of location data points, the one or more computer processors and computer storage further configured to detect geofence data associated with a train station, the match comprises a match between at least two of the plurality of location data points and the geofence data, and the match indicates that the user is on a train.

17. A computer-readable hardware storage device having embedded therein a set of instructions which, when executed by one or more processors of a computer, causes the computer to execute the following operations:
detecting geolocation data associated with the user;
detecting geolocation data associated with a plurality of public conveyances;
detecting a match between the geolocation data associated with the user and the geolocation data associated with one of the plurality of public conveyances; and
responsive to detecting the match, engaging the user electronically.

18. The computer-readable hardware storage device of claim 17 wherein the geolocation data associated with a plurality of public conveyances comprises the IP addresses of cruise ships or buses and detecting the match comprises detecting a match between the IP address of a mobile device of the user and the IP address of one of the plurality of public conveyances.

19. The computer-readable hardware storage device of claim 17 wherein the geolocation data associated with a plurality of public conveyances comprises the IP addresses of cruise ships or buses and detecting the match comprises detecting a match between the IP address of a mobile device of the user and the IP address of one of the plurality of public conveyances.

20. The computer-readable hardware storage device of claim 17 wherein the geolocation data associated with the user comprises a plurality of location data points, the method further including detecting geofence data associated with a train station, the match comprising a match between at least two of the plurality of location data points and the geofence data, and the match indicating that the user is on a train.
